(19) United States
(12) Patent Application Publication
(10) Pub. No.: US 2010/0216909 A1
(43) Pub. Date: Aug. 26, 2010

(54) BIODEGRADABLE COMPOSITION, PREPARATION METHOD AND THEIR APPLICATION IN THE MANUFACTURE OF FUNCTIONAL CONTAINERS FOR AGRICULTURAL AND/OR FORESTRY USE

(75) Inventors: Alex Berg Gebert, Mannheim (DE); Gustavo Cabrera Barja, Temuco (CL); Oscar Soto Sánchez, Temuco (CL)

Correspondence Address: MERCHANT & GOULD PC, P.O. BOX 2903, MINNEAPOLIS, MN, 55402-0903, US

(73) Assignees: UNIVERSIDAD DE CONCEPCION, Concepcion (CL); Alex Berg Gebert, Mannheim (DE)

(21) Appl. No.: 12/600,987

(22) PCT Filed: Sep. 30, 2008
(86) PCT No.: PCT/EP08/08362

§ 371 Date: Apr. 28, 2010

(30) Foreign Application Priority Data
Oct. 3, 2007 (CL) 2849-2007

(51) Int. Cl. C08K 5/15

(52) U.S. Cl. 523/128

(57) ABSTRACT

The present invention is a formulation for the production of a biodegradable container based on polylactic acid, lignocellulose fibers, lubricating additives, plastifiers, crystallinity modifiers, compatibilizers and functional additives. The lignocellulose fibers can be wood fibers and/or grape marc fibers, with a content that can vary between 0% and 75% of the mixture in weight; the polylactic acid content can vary between 0% and 80% of the mixture in weight; and the content of lubricating additives, plastifiers, crystallinity modifiers, compatibilizers and functional additives can vary between 0% and 10% of the mixture in weight.

### FIELD OF INVENTION

The present invention is a formulation for the production of a biodegradable container based on polylactic acid, lignocellulose fibers, lubricating additives, plastifiers, crystallinity modifiers, compatibilizers and functional additives. The lignocellulose fibers can be wood fibers and/or grape marc fibers, with a content that can vary between 0% and 75% of the mixture in weight; the polylactic acid content can vary between 0% and 80% of the mixture in weight; and the content of lubricating additives, plastifiers, crystallinity modifiers, compatibilizers and functional additives can vary between 0% and 10% of the mixture in weight.

### ESTATE OF THE ART

A great number of the devices used in the nursery stage of the forest and horticultural industries are manufactured with non-biodegradable thermoplastic resins: polypropylene, polyethylene and polystyrene. There are diverse applications for these materials in this stage; for example, containers (also known as tubettes), hand-carrying trays, boxes, pallets, plant pots, etc. which are of great importance, in the production process.

Every year the Chilean forest industry uses about 60 million containers made out of recycled polypropylene for its pine and eucalyptus seedlings. Here the used containers are collected and washed and only some of them are reused for the same purpose. The others are sent for recycling. Given the high volume of use, the recycling process generates a great quantity of recalcitrant and polluting material.

In addition, there are operating disadvantages with the use of the present containers. First, it is estimated that between 4% and 20% of the seedlings are lost through mechanical stress produced in their establishment when they are manually transplanted from the plastic container into the ground; and second, the costs of establishment in the total process (mainly labor costs) are critical with respect to the total costs of the plant production.

One possible solution to these problems is the manufacture of containers made out of biodegradable materials. This would allow the seedling to be established without being taken out of the container and the container would biodegrade once in contact with the soil. This would substantially reduce the possibility of post-transplant mechanical stress as well as the above-mentioned environmental effects.

At the present time, a wide variety of biodegradable containers are available on the market, mainly of cellulose fiber obtained from paper or compacted carton. However, these have serious disadvantages, which have restricted their use. The principal disadvantages of current biodegradable containers are the following: they are expensive, they have structural limitations, they become moisture-saturated during the cultivation process, they are not strong enough for handling, and basically they are not adjusted to the current technological design and mechanized state of the industry.

Biodegradable Thermoplastic Polyesters and Other Biodegradable Synthetic Polymers

Polyesters are the biodegradable thermoplastic materials that have had most commercial success. Some of them are described in the following section.

Biodegradable polyesters. Polyhydroxyalkanoates (PHAs), polylactic acid, polyglycolic acid, polylactic-co-glycolic acid, caprolactone, polybutylene terephthalate, polytetramethylene terephthalate, polybutylene succinate, polyethylene succinate, polyethylene succinate terephthalate, polybutylene succinate carbonate and polyadipate.

Polyhydroxyalkanoates (PHAs): this is the generic name of a family of polymers that includes more than 120 types of monomers. At the present time, the only polymers that are commercialized at an industrial level are polyhydroxybutyrate (PHB), polyhydroxyvalerate (PHV) and their copolymer polyhydroxybutyrate-valerate (PHBV). In the last-mentioned, the ratio between each type of monomer varies within the polymer.

These polymers can be processed with conventional extrusion and injection equipment and their properties are modifiable using additives or the formation of composite materials, so that they have a variety of uses.

The above-mentioned polyesters are not the only biodegradable polymers that are used as thermoplastic material or as filling for biodegradable formulations. Other polymers of commercial interest are polyvynilpirrolidone, polyvinyl alcohol, polyvinyl acetate and lignin.

Proteins with Thermoplastic Properties and as Thermoplastic Filling Material.

Some proteins have been used as filling material for biodegradable mixtures, among which are gelatine, silk moss, fibrin (silk protein), keratin, elastin, gluten of various origins, zein (corn protein) and soya protein.

Polysaccharides with Thermoplastic Properties and as Biodegradable Filling Material

Among the polysaccharides that possess thermoplastic properties are pregelatinized starch and some starch derivatives with amylase contents above 70%. Other semi-synthetic polysaccharides that can be processed like a conventional plastic are cellulose derivatives such as cellulose acetate, cellulose acetate phthalate, cellulose acetate butyrate and cellulose nitrate.

Numerous polysaccharides can be used as a filling for biodegradable compositions, among which are pectin, pectic acid, chitin, chitosan, cellulose and its non-thermoplastic derivatives, carrageenin, agar and agarose, alginate, laminarin, iridane, xantan, lentinan, glucomanans and galactomannans.

Cellulose and Lignocellulose Fibers as an Organic Filler and Strengthener.

These organic fibers are mainly used in the preparation of composite material of reinforced thermoplastic resins with natural fibers. Some of the natural fibers used commercially are jute, bamboo, henequen, cotton, sisal, albaca, linen, coconut, banana, bagasse, and waste from the wood industry such as sawdust and sanding dust

Other Inorganic Fillers

These materials include all inorganic compounds that, because of their low cost and availability, are used in thermoplastic mixtures. They are used as fillers to reduce the cost of the final product. Examples of these are all inorganic clays such as talc, zeolites, montmorillonite, hectorite, carbonates y inorganic sulfates, silicates, and natural and synthetic borosilicates. This group also includes other natural materials that contain one of these components in abundance, for example rice husk, which has a high silicate content.

Plastic Containers Used in Agriculture and Sylviculture

The fruit and forest industries have experienced rapid growth in the last 20 years, so that they have had to increase their cultivation capacity, especially at the seedling stage.

For this reason, the use of plastic containers has also increased in a range of enterprises involved in horticulture, the fruit and forest industries, and nurseries dedicated to the production of flowers and ornamental plants.

The plastic containers used at present are of different shapes and sizes, their design depending exclusively on their function in the cultivation process. As an example, Table 1 gives information about plastic containers of the “Arauco” type, widely used in the Chilean forest industry.

TABLE 1
Information about “Arauco” plastic containers.

| | | Lower | | | | |
|---|---|---|---|---|---|---|
| | Upper Diameter | Diameter | | | | Base |
| NAME | Exterior | Exterior | Height | | Capacity | Ventilation |
| TUBETTE | (mm) | (mm) | (mm) | Form | (mL) | Openings |
| ARAUCO 1 | 47 | 15 | 147 | Conica 1 | 140 | 4 |
| ARAUCO 2 | 47 | 15 | 147 | Conica 1 | 140 | 8 |

A review of invention patent applications related to forestry and agricultural biodegradable containers follows:

U.S. Pat. No. 2,728,169 claims the design and manufacture of a biodegradable container made of peat fibers reinforced with cellulose. This could be used for the germination and growth of seedlings, which can then be planted together with the container. Although these containers are biodegradable in terms of their composition, it has been demonstrated that once planted, the seedling roots have problems passing through the container walls because of their rigidity. Additionally, when there is a lack of water, the container walls compete with the plant roots for this resource so that the roots are deprived of the water they need.

U.S. Pat. No. 4,016,678 claims the design and production of a new type of container that is more resistant to the mechanization of sowing and transplanting. Some parts of the container are biodegradable, but not all. The proposal involves the use of crystalline polypropylene for the non-biodegradable content and cellulose or starches for the biodegradable content.

U.S. Pat. No. 496,328 claims the manufacture of a resistant paper for agricultural use. First, one sheet is made with cellulose fibers and then another with synthetic polymers of a different type. Then both sheets are joined to form a container that can be used to sow plants, but its mechanical properties are limited.

U.S. Pat. No. 5,058,320 claims the manufacture of a multicontainer system based on individual containers that can be interconnected. These containers are made of paper, which makes them biodegradable.

U.S. Pat. No. 5,155,935 claims the manufacture of containers for growing and transplanting plants that can be assembled in different ways. These containers are made of sheets of paper and are joined using a water-soluble paste. They have Y, N or V shaped openings in the walls to facilitate plant rooting after transplanting

U.S. Pat. No. 5,209,014 claims the manufacture of molds for plant growing and transplanting made of peat, a hydrophilic polymer of polyurethane, and water. They acquire the form of the mold in which the reaction mixture has been prepared and this mixture can also include nutrients for the plants added at the time of preparation.

U.S. Pat. No. 5,389,322 claims the manufacture of a biodegradable container formed of the following components: sanding dust 40%-46% (w/w), albumin protein 29%-35% (w/w), starch 17%-23% (w/w) and sodium metaphosphate 4%-6% (w/w). The product is made by compression molding. As an alternative, rice husk can replace the sanding dust, in the same concentration.

U.S. Pat. No. 5,651,214 claims the manufacture of a seed germination system composed of a group of individual biodegradable containers. This system includes the possibility of adding water and fertilizers. The material from which the containers would be made is not specified.

U.S. Pat. No. 5,683,772 claims the composition, method and system to manufacture biodegradable containers for use in the food industry using starch as a polymer matrix. Also claimed is the use of other components such as lignocellulose fibers, inorganic fillers, natural waxes and proteins, in combination with the starch matrix, to manufacture such objects.

U.S. Pat. No. 5,691,403 claims the composition of a biodegradable mixture based on starch, polylactic acid and oils that render the starch more hydrophobic.

U.S. Pat. No. 5,703,160 claims a biodegradable thermoplastic formulation based on starch or modified starch, a biodegradable polyester such as polylactic acid, polycaprolactone, PHB and a hydroxy acid salt as adjuvant.

U.S. Pat. No. 5,716,440 claims the preparation of moldable objects with biodegradable properties. These objects can be manufactured using fibers made from discarded sake boxes (sake is Japanese liquor), polysaccharides such as starch, ground egg shell, proteins, unrefined vegetable oils such as soya oil, fruit waste such as orange, grape or tomato peel, coffee and a plastifier. This mixture can be used to make containers for sausages, hamburgers, french fries, plants, and flowers, among others.

U.S. Pat. No. 5,783,505 claims the composition of a biodegradable and compostable mixture, composed of natural lignocelullose fibers of different origins, biodegradable polyesters or other polysaccharides. The lignocellulose fiber/polymer proportions in the mixture vary from 50/50 to 95/5. In addition, the biodegradability and compostability of the prepared materials are demonstrated, and it is shown that the speeds at which these processes occur are determined by the composition of the mixture.

U.S. Pat. No. 5,849,152 claims a formulation and the process for the production of biodegradable objects. This mixture is composed of lignocellulose fibers, pregelatinized starch and water. The lignocellulose fibers can be obtained from recycled paper, waste paper, wood dust or slices of sugar beet. These materials are subjected to a defibrating process before mixing them with starch. The fibers obtained must have a length of 0.5 mm-5 mm. To produce objects, a starch/fiber relationship of between 1:4 and 2:1 is used, respectively.

U.S. Pat. No. 5,939,467 claims a biodegradable polymer composition that can be processed in different forms such as films and fibers, for example. This mixture is composed of biodegradable polyesters, such as polylactic acid, commercial polyhydroxyalkanoates, polyurethanes and plastifiers.

U.S. Pat. No. 5,964,933 claims the manufacture and characterization of biodegradable materials from a mixture containing 51% to 70% of paper powder (w/w), and 30% to 49% of a biodegradable aliphatic polyester (w/w). It is indicated that this material biodegrades 100% in 90 days. The paper powder was obtained by grinding virgin pulp or used paper to a particle size of less than 2 mm. The patent also mentions the use of polylactic acid, PHB and PHBV as a biodegradable resin and the possible application in the manufacture of biodegradable containers for sowing plants. However, no examples of the manufacture of such materials are presented.

U.S. Pat. No. 5,983,566 claims the design of a container for the germination and transplanting of flowers and plants. This design consists of a rigid external container with a smaller biodegradable inner container, both in the form of a plant pot. The internal container can be removable and has holes that facilitate its biodegradation when the outer container is removed for the transplanting phase. The smaller container is made of cellulose or papier maché and may be used with fertilizers.

U.S. Pat. No. 6,096,809 claims the composition of a biodegradable mixture based on starch, a plastifier, biodegradable aliphatic or aromatic polyesters, polyurethanes, polyglycols and polyesteramides. These mixtures can be applied to the manufacture of films, fibers and injected products, depending on their composition.

U.S. Pat. No. 6,231,970 claims a mixture based on starch with a variety of fillers, of which lignocellulose fibers, polyesters, polysaccharides, proteins, and inorganic fillers are mentioned. General applications are suggested, such as the manufacture of films, sheets, containers and packing material.

U.S. Pat. No. 6,284,838 claims the composition of a biodegradable mixture based on lignin or a material that contains it (sanding dust), deprotonated proteins, polymers and copolymers of biodegradable polyesters such as PLA and PHB, and other fillers and additives. The manufacture of cups, containers, sheets and other biodegradable generic products are mentioned.

U.S. Pat. No. 6,350,531 claims the composition of a mixture for the manufacture of biodegradable articles. This mixture is composed of a biodegradable resin in a relation of 97%-58% (w/w), a natural fiber 1%-40% (w/w), a fertilizer 1%-40% (w/w) and other components such as pigments, pesticides or tensoactives 1%-10% (w/w). The sum of the last three elements should be 3%-42% (w/w), respectively. The natural fiber comes from the mesocarp of the coconut fruit. This fiber must be treated to eliminate the salts and the tannins before using. This treatment consists in leaving the fibers in the sun for 3 years so that they lose their color and the salts are eliminated; subsequently particle size is reduced. The fertilizers mentioned are traditional ones containing N, P, and K and include diatomic soils. The particle size of the fertilizers must be 1-80 μm. The biodegradable resin is based on polylactic acid, PHB and PHBV. This mixture is used to make biodegradable bags to store seeds, garbage bags, pipes, walls, engineering and medical materials, as well as sports articles. Among the examples mentioned is the manufacture by injection of containers for growing plants 500 μm wide. No further information about the form of the container is given.

U.S. Pat. No. 6,490,827 claims the manufacture of a system for sowing seedlings using a mixture of biodegradable materials. The mixture is a pulp that is suctioned into a mold to give it form, and subsequently subjected to hot pressing to give the final article its permanent form. Among the materials used are cellulose pulp from recycled paper and a biodegradable resin such as polylactic acid. The latter is incorporated into the mixture at a concentration equal to or less than 25% (w/w). This mixture also contains a fungicidal agent and a water repellant or water resistant agent.

U.S. Pat. No. 6,515,054 claims the composition of a biodegradable mixture composed of a biodegradable resin such as polylactic acid, a filler that is a starch and an anionic tensoactive product. The biodegradable resin can be 30%-90% (w/w) of the mixture, the filler 5%-30% (w/w) and the surfactant 0.05%-20% (w/w). The relation of biodegradable resin/filler in the mixture must be 30/70 to 90/10% (w/w).

U.S. Pat. No. 6,533,854 claims the manufacture of objects with a biodegradable mixture of lignocellulose fibers, native starch and pregelatinized starch.

U.S. Pat. No. 6,632,925 claims a biodegradable mixture based on plant protein, between 5-95% (w/w), polylactic acid between 85.1-4.9% (w/w) and a compatibilizer between 0.1-9.9% (w/w).

U.S. Pat. No. 6,669,771 claims the composition of a biodegradable functional mixture based on biodegradable polyesters, nucleate agents and the degradation products from the polysaccharide family known as mannans. The presence of mannan oligomers, glucomanans and galactomannans render the mixture functional as a bactericide and can be in a proportion of up to 40% (w/w). Some of the biodegradable resins that can be used in the present invention are polylactic acid, PHB and PHBV. The nucleate agents can be talcs, carbonates, borox and titanium oxide. It is demonstrated that the presence of the degradation products favors the biodegradation of the product. Possible applications of this mixture mentioned are the manufacture of a variety of generic products such as bottles, fishing nets, agricultural materials for vegetation and plastics for greenhouses.

U.S. Pat. No. 6,806,353 claims a formulation based on plant protein, such as soya protein that is used at a level of 5%-90% (w/w), and a polyester such as polylactic acid and/or caprolactone, used at 5%-90% (w/w). The formulation includes a plastifier, a crossing agent and a compatibilizer in concentrations of 1%-10% (w/w).

U.S. Pat. No. 6,878,199 claims a mixture used to manufacture a biodegradable container for storing food. This mixture is 5%-60% starch (w/w), wood fibers with an Aspec relation of 1:2 and 1:8, used at a level of 11%-24% (w/w), polysaccharides, inorganic fillers and plastifying additives. First, the biodegradable article is formed and then it is covered with a film of a different material that is also biodegradable. These materials could be biodegradable polyesters, polysaccharides and their derivatives, fats and coverings based on oils. Utensils mentioned from these materials include cutlery, coffee cups, glasses, trays, and trays for microwave ovens.

US invention patent application 20030041516 claims the composition of a mixture used in the manufacture of biodegradable containers for the germination and development of plants. This mixture is based on a combination of ground pine bark and/or rice husks 50%-100% (w/w), peat 0%-30% (w/w), fertilizer 0%30% (w/w), soil 0%-30% (w/w), controlled release nutrients, other organic materials, and a biodegradable organic agglutinant that is water sensitive, such as guar gum or corn starch. The container retains its form while in use. But it disintegrates easily when the container is buried together with the plant in a damp environment. The container model proposed has walls up to two inches thick, and is similar to traditional plant pots in its shape and capacity. These can be buried using a drill that has specially sharpened pieces with depth control blades designed to be adjusted to the container.

US invention patent application 20050089606 claims a mixture for the manufacture of biodegradable food and drink. These containers are based on starch, natural fibers, inorganic fillers, polysaccharides, proteins, waxes or fats and an insolubilizing agent.

US invention patent application 20050120915 claims a method and a composition to produce biodegradable objects, composed of starch, wood or paper fibers and water. These objects include cups, plates, and utensils, but not tubettes.

US invention patent application 20050158541 claims the manufacture of biodegradable moldable products made from a mixture of starch, polysaccharides, lignocellulose fibers and water.

US invention patent application 20050188612 claims the manufacture of a plant container with biodegradable characteristics, made of biodegradable plastic that is a combination of polylactic acid and a natural fertilizer. The fertilizer is ground coffee grains mixed with salts that provide nitrogen, phosphorus and potassium (N—P—K). The outside of the container is covered by a layer of shellac, a biodegradable plastic from the lac beetle, that is applied like a paint and is water resistant. In this way the container resists humidity during the plant's growing period. When the container is buried with the plant, it biodegrades, allowing the plant roots to pass through its wall, while at the same time fertilizing the soil. One product mentioned is the conic container 4 inches wide and 4 inches deep with a flat bottom and a ¼ inch hole in the center. This mixture could be used for films, plant trays, or bigger plant containers.

### DESCRIPTION OF THE INVENTION

This patent application proposes the production of a container made of biodegradable material based on polylactic acid, lignocellulose fibers, lubricating additives, plastifiers, crystallinity modifiers, compatibilizers and functional additives

The following section describes the manufacturing process for pellets of composite material from which the biodegradable products will be made.

The lignocellulose fibers can be wood fibers and/or grape marc fibers, with a content that can vary between 0% and 75% of the mixture in weight, preferably between 50% and 60% in weight.

The polylactic acid content can vary between 0% and 80% of the mixture in weight, preferably between 30% and 50% in weight.

The content of lubricating additives, plastifiers, urea-formaldehyde resins, and compatibilizers can vary between 0% and 10% of the mixture in weight, preferably between 0.5% and 3% in weight.

Lignocellulose Fiber Conditioning.

The lignocellulose fiber conditioning includes the grinding, sieving and drying processes. There are two main sources of lignocellulose fibers: wood and grape marc.

Wood lignocellulose fibers: the wood fibers that will be used in the preparation of the biodegradable material are an industrial sub-product (for example, from sawmills), which guarantees the supply of an abundant raw material commercialized at a very low price, as it is considered to be waste. The lignocellulose material can be found in different forms: sanding dust, sawdust, fibers and flakes, among others. As all these substances have different granulometries, density and water absorption capacity, the control variables in the process vary according to the type of raw material used. It is therefore necessary to apply a pretreatment to the material in order to standardize its physical-chemical characteristics. Thus, for example, it is necessary to grind, sieve and dry the raw material in various stages, depending on its initial form: fibers, flakes, powder, etc. In this process the size of the fiber that can be used varies between 0.5 mm and 2 mm, with a maximum humidity of 2% (w/w).

Grape marc lignocellulose fibers: Dry grape marc is a waste product from the viticulture industry. It consists of dry skins and pips of grapes that have been processed to make wine and that are generally left to be composted and used as fertilizer. The chemical composition depends on the type of grape. The principal difference in comparison with wood dust lies in the content of lignins, soluble sugars and antioxidants present in the cell wall.

Other Functional Additives and Products Added to the Pellet Made from the Biodegradable Mixture

Additives that improve the processability of the material. These additives facilitate the mixing of the materials and add other important properties to the final product. The type of additive depends on the final use of the product. For example:
Compatibilizing agents: Polylactic acid grafted with cellulose, PHB and PHBV grafted with cellulose, other lineal polyolefins grafted with cellulose.
Lubricators and plastifiers: Stearic acid and its esters, high molecular weight polyols and alcohols, for example, glycerol, glycerol monoacetate, diglycerol, glycerol diacetate or triacetate, triethyleneglycol, diacetin sorbitol, sorbitan, mannitol, malitol, ethyleneglycol, propyleneglycol, polyvinyl alcohol, sodium cellulose glycolate, cellulose methyl ether, triethyl citrate, diethyl citrate, polyethyleneglycols, propylenglycols, 1,2,6-hexanotriol, triethylamine, caprolactone, short-chain hydroxyalcanoic acids such as hydroxybutanoic acid and hydroxycaproics, some sugars and their derivatives and their mixtures. Polycaprolactone oligomers, PHB and PHBV are also used as plastifiers, as well as epoxydated oils, long-chain fatty acids, with 10 to 30 carbon atoms in their structure.
Crystallinity modifiers: Saccharin and/or talc, the content of which can vary between 0% and 20% of the mixture in weight, preferably between 1% and 10% in weight.

Functional Products added to the mixture. These products give biological properties to the mixture. While the container is biodegrading, they are slowly released to fulfill their function. One important limitation in their use is that these products must resist processing temperatures up to approximately 250° C., without degrading or changing their chemical structure. The next section classifies them according to their biological activity. The total content of functional additives must vary between 0% and 25% of the mixture in weight, preferably between 1% and 10% in weight.

Plant growth regulators, in a concentration that can vary between 0.01% and 10% in weight. These include pectin oligomers known as oligopectates, oligoalginates with different G/M relations (0/100), oligocarragenanes (lambda, iota, kappa), oligochitines and oligochitosans with different levels of acetylation, lineal oligoglucanes with a beta link (1-3) or beta lineals (1-3) with ramifications (1-6), oligoagarans (derived from agar), sulfated oligogalactans, proteins such as harpine, enzymatic hydrolysates from plant and animal proteins, amino acids.

Biocidal products, in a concentration that can vary between 0.01% and 10% in weight. Natural extracts such as Quillay saponins, natural tannins of different origins, extracts rich in flavonoids from medicinal or native plants, garlic and aniseed extract, propoleum, polylysine, polyarginine, chitosans and their derivatives, polysaccharide salts or natural polymers that contain Zn, Cu, Ag, such as Zn alginate, Cu carragenate or Zn carboxymethylcellulose or their mixtures, acidic proteins such as spermine and zein, metallic micro and nanoparticles that contain Cu, Zn and Ag, respectively.

Fertilizers, in a concentration that can vary between 0.01% and 10% in weight. Fertilizers including natural fertilizers such as humic and fulvic acids, urea, urea-formaldehyde resins of low molecular weight, and salts containing N, P and K.

The manufacturing process of a functional biodegradable container includes the following stages:

a. Conditioning of the lignocellulose fibers;

b. incorporation of compatibilizing agents;

c. incorporation of lubricating and plastifying agents;

d. incorporation of crystallinity modifiers of the mixture;

e. incorporation of additives with functionality;

f. preparation of the pellet;

g. manufacture of the container by injection using composite material pellets.

Pellet Preparation Process

Pellet preparation by extrusion. Extrusion is a way of manufacturing biodegradable pellets based on bioplastics. Once the lignocellulose fibers are dry, they are melt blended in the extruder with the thermoplastic resin and the other additives or products. The mixture takes the form of pellets, their final shape depending on the headstock through which the melt blended material flows. Once cooled, the pellets can be stored until used.

Manufacture of Products from Composite Material Pellets

Injected products. Biodegradable composite material pellets made by extrusion or mixing can be used for the manufacture of injected products. The pellets are added to the injecting machine, where they melt, are mixed and then injected into a mold or cavity with a defined form.

Pressed products. The biodegradable pellets described above can be used to manufacture pressed objects. The pellets are placed in the pressing equipment, which consists of two heating plates that can be used at the desired temperature. The plates come together and enough force is applied to melt the pellets, mix them and give them the form of the sheets.

### BRIEF DESCRIPTION OF THE DRAWINGS

FIG. 1 shows the dimensional stability tests determined according to Chilean norm NCh 793 of 1973, in which injected cores of known sizes (2.5×2.5 cm), free of defects, are placed in water for 24 hours. The results are expressed as an inflation percentage at 2 and 24 hours, respectively.

As seen in FIG. 1, the biodegradable mixtures based on APL and sanding dust or grape marc absorb very little water (<3%) at 24 hours. As the hydrophilic material content in the mixture increases, the water absorption of the material increases, as in the mixture that reached 6% water absorption. In general, low water absorption indicates high dimensional stability. This would allow the injected final product to fulfill, stability requirements for one year, merely by varying the composition of the mixture without adding any extra impermeabilizer.

FIG. 2 shows the thermogravimetric curves of samples of grape marc, APL and the mixture of these components with stearic acid.

As observed, a homogenization of the thermal properties of the mixture occurs with respect to the initial grape marc. This indicates the obtention of a homogeneous biodegradable mixture with a decomposition temperature less than that of APL.

FIG. 3 shows a biodegradable container made of pellets with the composition described in Tables 4 to 7, designed for use in the nursery stage by forestry companies. The process was carried out with a set of temperatures in the different parts of the extruder ranging between 150° C. and 170° C. The pellets were injected in an Auburn injector at a pressure of 250 tons, and an 8-cavity mold.

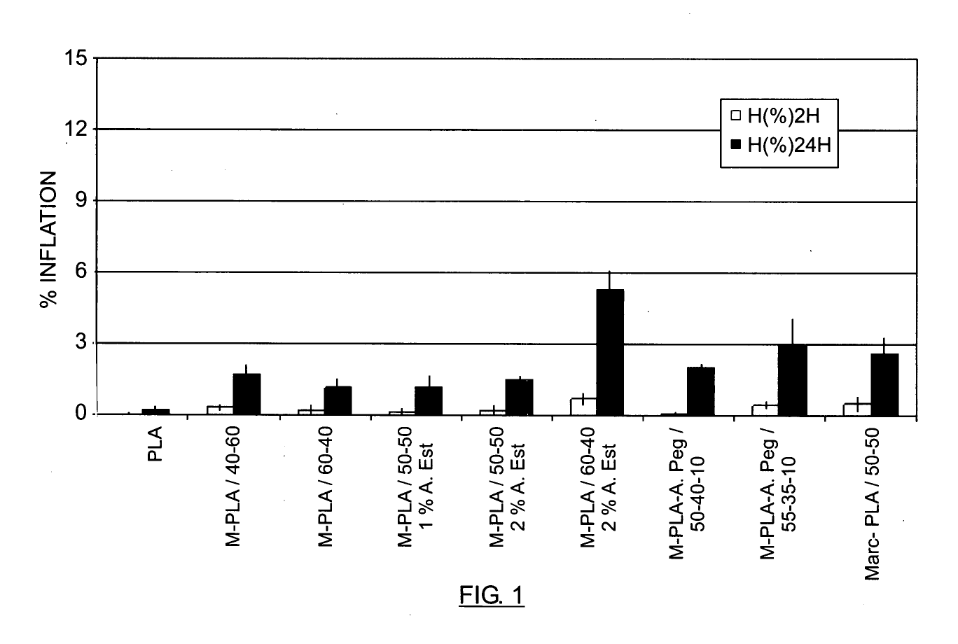

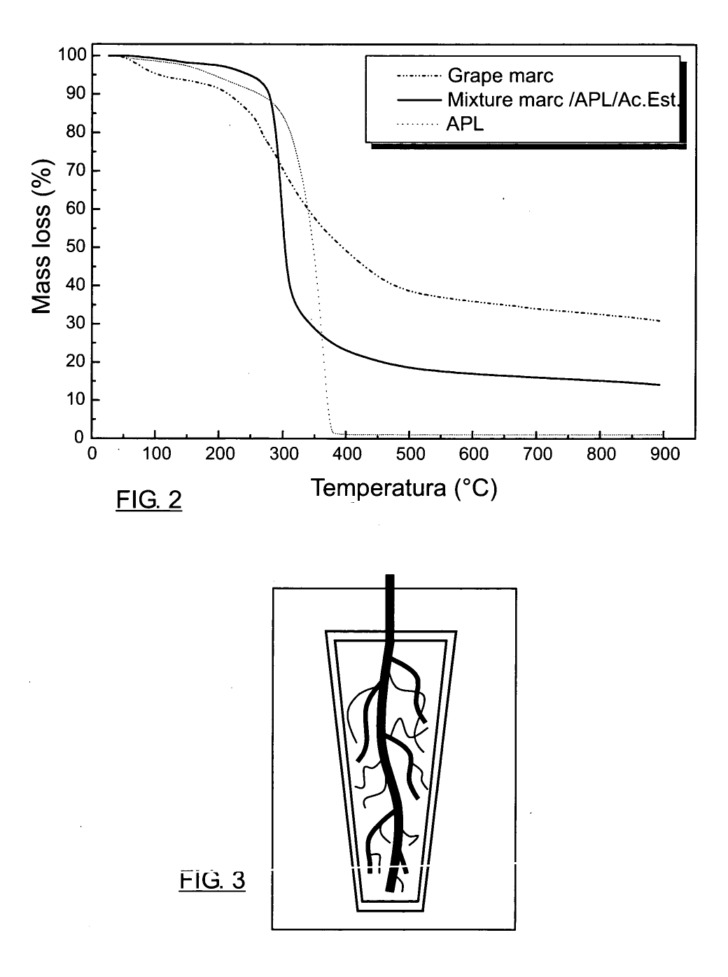

### EMBODIMENTS

### Characteristics of Commercial Biodegradable Resins

Commercial name: Biocycle 2000—Polyhydroxibutirate-valerate (PHB/HV) Supply company: PHB Industrial S/A—BRAZIL

TABLE 2
Physical-mechanical properties of PHBV.

| | Methodology | | |
|---|---|---|---|
| Physical properties | ASTM | Units | Values |
| Density - 23° C. | D-0792 | g/cm3 | 1.23 |
| Fluency index MFI 2.6 | D-1238 | g/10 min | 25.00 |
| (190° C.) | | | |
| Tensile strength | D-638 | MPa | 23.40 |
| Elongation | D-638 | % | 8.00 |
| Impact Resistance | D-256 | J/m | 35.00 |
| (Notched Izod) | | | |
| Fusion temperature | DSC | ° C. | 170.4 |
| Monomer | | % | 10 |
| concentration | | | |

Commercial name: Polylactic Acid HM 1010 (PLA)

Supply company: Hycail BV—NETHERLANDS

TABLE 3
Physical properties of APL.

| Physical properties | Methodology | Units | Values |
|---|---|---|---|
| Density - 23° C. | ASTM D-0792 | g/cm3 | 1.25 |
| Fusion temperature | DSC | ° C. | 160 |

### Example 1

### Preparation of PHBV-Based Pellets in the Mixer, and the Mechanical Properties of the Composite Material

Table 4 shows the composition of different mixtures that can be prepared using lignocellulose fibers: in this case, sanding dust, a biodegradable thermoplastic resin and starch. This process was carried out at a temperature of 170° C., which is the fusion temperature of PHBV, and lasted approximately 10 minutes. The pellets were injected in an Auburn injector at a pressure of 100 tons, in order to obtain cores used for measuring the mechanical properties according to ASTM 638 and 790, respectively.

TABLE 4
Composition of the mixtures for obtaining different PHBV-based
pellets.

| | | | | Tensile | Flexion | |
|---|---|---|---|---|---|---|
| | PHBV | | Wood dust | resistance | resistance | Camping |
| N^{o} | (%) | Starch (%) | (%) | (MPa) | (MPa) | index |
| 1 | 100 | 0 | 0 | 25 | 37 | 0.91 |
| 2 | 80 | 20 | 0 | 18 | 31 | 1.02 |
| 3 | 70 | 30 | 0 | 15 | 29 | 0.98 |
| 4 | 90 | 0 | 10 | 25 | 40 | 1.00 |
| 5 | 80 | 0 | 20 | 22 | 38 | 1.12 |
| 6 | 70 | 0 | 30 | 21 | 35 | 1.00 |
| 7 | 70 | 10 | 20 | 18 | 30 | 0.98 |

### Example 2

### Preparation of APL-Based Pellets in the Mixer, and the Mechanical Properties of the Composite Material

Table 5 shows the composition of different mixtures that can be prepared using lignocellulose fibers: in this case, sanding dust, a biodegradable thermoplastic resin and starch. This process was carried out at a temperature of 160° C., which is the fusion temperature of APL, and lasted approximately 10 minutes. The pellets were injected in an Auburn injector at a pressure of 100 tons, in order to obtain cores used for measuring the mechanical properties according to ASTM 638 and 790, respectively.

TABLE 5
Composition and mechanical properties of APL-based composite
materials.

| | | | | Tensile | Flexion | |
|---|---|---|---|---|---|---|
| | APL | | Word dust | resistance | resistance | Camping |
| N^{o} | (%) | Starch (%) | (%) | (MPa) | (MPa) | index (%) |
| 1 | 100 | 0 | 0 | 55 | 94 | 0.58 |
| 2 | 90 | 0 | 10 | 42 | 68 | 0.32 |
| 3 | 60 | 0 | 40 | 35 | 39 | 0.31 |
| 4 | 70 | 10 | 20 | 22 | 40 | 0.36 |

### Example 3

### Preparation of APL-Based Pellets in the Extruder, and the Mechanical Properties of the Composite Material

Table 6 shows the composition of different mixtures that can be prepared using lignocellulose fibers: in this case, sanding dust, a biodegradable thermoplastic resin (APL) and starch. This process was carried out using a set of temperatures in different parts of the extruder between 150° C. and 170° C. The pellets were injected in an Auburn injector at a pressure of 100 tons in order to obtain cores for measuring the mechanical properties according to ASTM 638 and 790, respectively.

TABLE 6
Composition and mechanical properties of APL-based composite
materials.

| | | | | | Elasticity | Flexion | Traction |
|---|---|---|---|---|---|---|---|
| | Wood dust | | | Lubricant | module | resistance | resistance |
| N^{o} | (%) | PLA (%) | Starch (%) | (%) | (MPa) | (MPa) | (MPa) |
| 1 | 40 | 60 | 0 | 0 | 6731.1 | 49.8 | 19.1 |
| 2 | 60 | 40 | 0 | 0 | 6418.6 | 64.2 | 33.9 |
| 3 | 50 | 50 | 0 | 1 | 6562.9 | 47.0 | 27.3 |
| 4 | 50 | 50 | 0 | 2 | 6043.9 | 65.4 | 44.8 |
| 5 | 60 | 40 | 0 | 2 | 6401.2 | 37.1 | 17.7 |
| 6 | 50 | 40 | 10 | 0 | 5969.6 | 64.2 | 40.1 |
| 7 | 55 | 35 | 10 | 0 | 6695.2 | 54.3 | 26.2 |
| 8 | 0 | 100 | 0 | 0 | 3743.4 | 116.2 | 60.7 |

Microphotographs obtained through scanning electronic microscopy (SEM) from the cores injected from mixture 3 prove that the sanding mixture forms a homogeneous mixture with the polylactic acid in the presence of a lubricant and that it acts as a strengthening fiber.

### Example 4

### Preparation of APL-Based Pellets in the Extruder, and Thermal Properties of the Composite Mixture

Table 7 shows the composition of the mixture prepared using lignocellulose fibers: in this case, dry grape marc, a biodegradable thermoplastic resin (APL) and a lubricant. This process was carried out using a set of temperatures in different parts of the extruder between 150° C. and 170° C. The pellets were used to determine thermal properties.

TABLE 7
Composition and thermal properties of the APL-based composite
materials.

| | Grape | | | | | |
|---|---|---|---|---|---|---|
| | marc | PLA | Lubricant | T_{D} | T_{D} | T_{D} |
| N^{o} | (%) | (%) | (%) | marc | APL | Mixture |
| 1 | 50 | 50 | 2 | 264.9 | 363.5 | 300.6 |
| | | | | 304.5 | | |

### Example 5

### Preparation of Pressed Board Using Pellets Based on APL and Grape Marc

1 kg of pellets made of the composite material described in Table 7 were put into a manual press 40×40 cm in size at a temperature of 155° C., and a pressure of 2 atm was applied for 5 minutes. This material has a characteristic dried grape smell, good mechanical properties and a characteristic color, which also comes from the dry grape marc.

### Example 6

### Preparation of Injected Samples Using Pellets Based on APL and Grape Marc

The composite material pellets obtained in Example 4 were injected to obtain standard cores, which indicates that the sample can be injected. Micrographs obtained through scanning electronic microscopy (SEM), from the cores injected with the criofractured APL/grape marc/stearic acid mixture proved that the grape marc acts as a strengthening fiber and that the material incorporates pieces of grape cell wall.

### Example 7

### Preparation of Filaments Using Pellets Based on APL and Grape Marc

The composite material pellets obtained in Example 4 were put in a capillary rheometer at a temperature of 175° C. and the rheometer piston was used to generate pressure to obtain filaments of the material.

### Example 8

### Preparation of a Biodegradable Container Using Pellets Based on APL and Wood Dust

A functional biodegradable container was developed from a mixture of materials that fulfilled the technological requirements of the agroforestal sector and also offered additional cultivation advantages. The following requirements are fulfilled:
1. All the materials from which the container is manufactured are biodegradable and compostable.
2. The container possesses the mechanical properties to withstand all the operational handling in the preparation, sowing and transplanting phases, both manual and with specialized machinery.
3. The container will survive the growing time of the seedlings in the nursery stage, before they are established, without appreciable degradation, keeping its mechanical consistency.
4. If during transplanting the plant is not taken out of the container, the container will biodegrade, but only under anoxic conditions (temperature, pH, humidity, anoxia and microorganisms)
5. The mixture from which the container is made contains additives that give the container additional functionality. Most of these additives are natural and therefore biodegradable. They are compatible with the mixture, do not decompose during the process, and are released while the container biodegrades.
6. The price of the biodegradable containers is competitive with that of traditional containers or the advantages of their use are so marked that companies are prepared to pay a higher price in order to use them.

1. Formulation for the manufacture of biodegradable forestry containers comprising: polylactic acid, lignocellulose fibers, lubricating additives, plastifiers, crystallinity modifiers, compatibilizers and functional additives.

2. Formulation for the manufacture of biodegradable forestry containers according to claim 1, wherein the lignocellulose fibers can be wood fibers and/or grape marc fibers, ground, sieved and dried with a content that can vary between 1% and 75% of the mixture in weight, preferably between 50% and 60% in weight, with a fiber size that can vary between 0.5 mm and 2 mm, and with a maximum moisture content of 2% (w/w).

3. Formulation for the manufacture of biodegradable forestry containers according to claim 1, wherein the polylactic acid content can vary between 1% and 80% of the mixture in weight, preferably between 30% and 50% in weight.

4. Formulation for the manufacture of biodegradable forestry containers according to claim 1, wherein the content of lubricating additives, plastifiers and compatibilizers can vary between 0% and 10% of the mixture in weight, preferably between 0.5% and 3% in weight.

5. Formulation for the manufacture of biodegradable forestry containers according to claim 1, wherein the compatibilizer additives can be polylactic acid grafted with cellulose, PHB and PHBV grafted with cellulose, or other lineal polyolefins grafted with cellulose and the lubricating additives and plastifiers can be stearic acid and its esters, high molecular weight polyols and alcohols, such as, glycerol, glycerol monoacetate, diglycerol, glycerol diacetate or triacetate, triethyleneglycol, diacetin sorbitol, sorbitan, mannitol, malitol, ethyleneglycol, propyleneglycol, polyvinyl alcohol, sodium cellulose glycolate, cellulose methyl ether, triethyl citrate, diethyl citrate, polyethyleneglycols, propylenglycols, 1,2,6-hexanotriol, triethylamine, caprolactone, short-chain hydroxyalcanoic acids such as hydroxybutanoic acid and hydroxycaproics, some sugars and their derivatives and their mixtures, polycaprolactone oligomers, PHB, PHBV, epoxydated oils, long-chain fatty acids, with 10 to 30 carbon atoms in their structure.

6. Formulation for the manufacture of biodegradable forestry containers according to claim 1, wherein the crystallinity modifiers can be saccharin and/or talc, the content of which can vary between 0% and 20% of the mixture in weight, preferably between 1% and 10% in weight.

7. Formulation for the manufacture of biodegradable forestry containers according to claim 1, wherein the functional additives can be growth hormones in a concentration that can vary between 0.01% and 10% in weight, such as oligopectates, oligoalginates with different G/M relations (0/100), oligocarragenanes, oligochitines and oligochitosans with different levels of acetylation, lineal oligoglucanes with a beta link (1-3) or beta lineals (1-3) with ramifications (1-6), oligoagarans (derived from agar), sulfated oligogalactans, harpine, enzymatic hydrolysates from plant and animal proteins, and/or aminoacids; biocidal products, in a concentration that can vary between 0.01% and 10% in weight, such as Quillay saponins, natural tannins of different origins, extracts rich in flavonoids from medicinal or native plants, garlic and aniseed extract, propoleum, polylysine, polyarginine, chitosans and their derivatives, polysaccharide salts or natural polymers that contain Zn, Cu, Ag, such as Zn alginate, Cu aragonite or Zn carboxymethylcellulose or their mixtures, spermine and zein, metallic micro and nanoparticles that contain Cu, Zn and Ag; fertilizers, in a concentration that can vary between 0.01% and 10% in weight, such as humic and fulvic acids, urea, urea-formaldehyde resins of low molecular weight, and salts containing N, P and K.

8. Formulation for the manufacture of biodegradable forestry containers according to claim 1, wherein the total content of functional additives must vary between 0% and 25% of the mixture in weight, preferably between 1% and 10% in weight.

9. A process to manufacture biodegradable forestry containers comprising the following stages:
a. Conditioning of the lignocellulose fibers;
b. incorporation of compatibilizing additives, crystallinity modifiers of the mixture, lubricators and plastifiers;
c. incorporation of functional additives;
d. preparation of the pellet;
e. manufacture of the container by injection using composite material pellets.

10. A process to manufacture biodegradable forestry containers according to claim 9, wherein the conditioning of the lignocellulose fibers includes the grinding, sieving and drying processes.

11. A process to manufacture biodegradable forestry containers according to claim 9, wherein the size of the fiber that can be used can vary between 0.5 mm and 2 mm with a maximum moisture content of 2% (w/w).

12. A process to manufacture biodegradable forestry containers according to claim 9, wherein the preparation of the pellets is carried out through extrusion.

13. A process to manufacture biodegradable forestry containers according to claim 9, wherein the products are made from pellets through injection or pressing.
